(19) United States
(12) Patent Application Publication
(10) Pub. No.: US 2025/0251735 A1
(43) Pub. Date: Aug. 7, 2025

(54) SYSTEM AND METHOD FOR CONFINING ROBOTIC DEVICES

(71) Applicant: Ali Ebrahimi Afrouzi

(72) Inventor: Ali Ebrahimi Afrouzi

(73) Assignee: Al Incorporated, Toronto (CA)

(21) Appl. No.: 18/432,901

(22) Filed: Feb. 5, 2024

(51) Int. Cl. G05D 1/622; G05D 1/243

(52) U.S. Cl. CPC G05D 1/637; G05D 1/243

(57) ABSTRACT

Aspects include a method for operating a robot, including: capturing, with a sensor disposed on the robot, sensor data of objects within an environment of the robot as the robot moves within the environment; identifying, with a processor, at least a first object among a plurality of objects within the environment based on the sensor data; generating, with the processor, a virtual boundary adjacent to a location of the at least the first object; and actuating the robot to avoid crossing locations within the environment corresponding with the virtual boundary.

### CROSS-REFERENCE TO RELATED APPLICATIONS

This application is a Continuation of U.S. Non-Provisional patent application Ser. No. 18/120,775, filed Mar. 13, 2023, which is a Continuation of U.S. Non-Provisional patent application Ser. No. 17/071,424, filed Oct. 15, 2020, which is a Continuation of U.S. Non-Provisional patent application Ser. No. 15/674,310, filed Aug. 10, 2017, which claims the benefit of U.S. Provisional Patent Application No. 62/373,512, filed Aug. 11, 2016, each of which is hereby incorporated by reference.

### FIELD OF THE DISCLOSURE

The present invention relates to robotic systems, and more particularly, to methods for confining or limiting the movement of robotic devices.

### BACKGROUND

Several systems for confining robotic devices to specific physical space for the purpose of performing work have been proposed in prior art. Such work may include floor cleaning, lawn care, and transportation. One approach toward confining robotic devices may be the use of large physical barriers to block the robotic device from entering, or becoming proximate with, one or more objects and/or areas of operation. However, this solution is neither efficient nor practical as physical barriers may encumber routine movement throughout the area of operation and an undesirable degree of human intervention is required. In prior art, sophisticated navigation systems have been used whereby the robot is trained or programmed to travel along predetermined paths or its position is monitored within a stored map. In such navigation systems large amounts of memory are required to store information related to each location. This is undesirable, particularly in cases where the robotic device is to be used in various locations as a large amount of memory would be required. The robotic device may also need to be trained or re-programmed for each new location or each time the work area is changed which is unpractical for consumer use. Other approaches in prior art include the installation of cables or wires to define the boundary of an area. These may be aesthetically unpleasing and can be a tripping hazard. Furthermore, installation may be difficult as cables or wires are ideally to be placed underground or beneath carpet. These methods mentioned in addition to other prior art proposed may not be ideal as they often require the use of additional equipment and substantial setup. The present invention addresses these issues by introducing a method for confining and/or modifying the movement of a robotic device by means of a recognizable boundary component which may already pre-exist within the working area. Once recognized, the boundary component can be used to erect virtual boundaries.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

Some aspects include a method for operating a robot, including: capturing, with a sensor disposed on the robot, sensor data of objects within an environment of the robot as the robot moves within the environment; identifying, with a processor, at least a first object among a plurality of objects within the environment based on the sensor data; generating, with the processor, a virtual boundary adjacent to a location of the at least the first object; and actuating the robot to avoid crossing locations within the environment corresponding with the virtual boundary.

Some aspects provide a robot, including: a chassis; a set of wheels coupled to the chassis; and a plurality of sensors; wherein: the sensor is configured to capture sensor data of objects within an environment of the robot as the robot moves within the environment; a processor is configured to identify at least a first object based on the sensor data; the processor is further configured to generate a virtual boundary adjacent to a location of the at least the first object based on identifying the at least the first object among a plurality of objects within the environment; and the robot is configured to avoid crossing locations within the environment corresponding with the virtual boundary.

### BRIEF DESCRIPTION OF THE DRAWINGS

FIG. 1A illustrates a side view of a robotic device with an image sensor and line laser diode, according to some embodiments.

FIG. 1B illustrates a front view of an image captured of the line laser projected onto the flat surface in FIG. 1A.

FIG. 2 illustrates a top view of the operation of a confinement system with robotic device and an example of a boundary component, according to some embodiments.

FIG. 3A illustrates atop view of an example boundary component, according to some embodiments.

FIG. 3B illustrates a front view of an image captured of the line laser projected onto the surface of the example boundary component in FIG. 3A.

FIG. 4 illustrates a front view of a robotic device, according to some embodiments.

### DETAILED DESCRIPTION OF SOME EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that include a computer-readable medium on which computer-readable instructions for carrying out embodiments of the inventive technique are stored. The computer-readable medium may include semiconductor, magnetic, opto-magnetic, optical, or other forms of computer-readable medium for storing computer-readable code. Further, the invention may also cover apparatuses for practicing embodiments of the invention. Such apparatus may include circuits, dedicated and/or programmable, to carry out tasks pertaining to embodiments of the invention. Examples of such apparatus include a computer and/or a dedicated computing device when appropriately programmed and may include a combination of a computer/computing device and dedicated/programmable circuits adapted for the various tasks pertaining to embodiments of the invention. The disclosure described herein is directed generally to providing virtual boundaries and location indicators for limiting surface coverage and navigating robotic devices.

As understood herein, the term “image sensor” may be defined generally to include one or more sensors that detect and convey the information that constitutes an image by converting the variable attenuation of light waves into signals. The term “image processor” may be defined generally to include an image processing engine or media processor that uses signal processing to extract characteristics or parameters related to an input image.

As understood herein, the term “robot” or “robotic device” may be defined generally to include one or more autonomous or semi-autonomous devices having communication, mobility, and/or processing elements. For example, a robot or robotic device may comprise a casing or shell, a chassis including a set of wheels, a motor to drive wheels, a receiver that acquires signals transmitted from, for example, a transmitting beacon, a processor and/or controller that processes and/or controls motors and other robotic autonomous or cleaning operations, network or wireless communications, power management, etc., and one or more clock or synchronizing devices.

Some embodiments include a system and method for confining and/or modifying the movement of robotic devices.

In some embodiments, the movement of a robotic device is confined or limited by means of a boundary component. The boundary component is placed within an area co-located with the robotic device. The boundary component may have a predefined pattern in form of a predetermined surface indentation pattern that may be discerned by a sensor component installed onto the robotic device.

A robotic device configured with a line laser emitting diode, an image sensor, and an image processor detects predetermined indentation patterns of surfaces within a specific environment. The line laser diode emits the line laser upon surfaces within the field of view of the image sensor. The image sensor captures images of the projected line laser and sends them to the image processor. The image processor iteratively compares received images against the predetermined surface indentation pattern of the boundary component. Once the predefined pattern in the form of the predetermined indentation pattern is detected the robotic device may mark the location within the working map of the environment. This marked location, and hence boundary component, may be used in confining and/or modifying the movements of the robotic device within or adjacent to the area of the identified location. This may include using the marked location to avoid or stay within certain areas or execute pre-programmed actions in certain areas.

Some embodiments include a method for confining or limiting the movement of robotic devices by means of a boundary component. The boundary component is placed within an area co-located with the robotic device. The boundary component may have a predefined pattern in the form of a predetermined surface indentation pattern that may be recognized by the robotic device and used to identify boundaries. A robotic device configured with a line laser emitting diode, an image sensor, and an image processor detects predetermined indentation patterns of surfaces within a specific environment. The image sensor and image processor detect the predetermined indentation pattern by continuously analyzing the projections of the line laser diode disposed on the robotic device. The line laser diode emits the line laser upon surfaces within the field of view of the image sensor. The image sensor captures images of the projected line laser and sends them to the image processor. The image processor iteratively compares received images against the predetermined surface indentation pattern of the boundary component. Once the predefined pattern in the form of the predetermined indentation pattern is detected the robotic device may mark the location within the working map of the environment. This marked location, and hence boundary component, may be used in confining and/or modifying the movements of the robotic device within or adjacent to the area of the identified location. This may include using the marked location as a boundary to avoid or stay within certain areas or execute pre-programmed actions in certain areas. For example, areas adjacent to the boundary component may be marked as off-limit areas by the robotic device thereby confining and/or modifying its movement within the working area. The boundary component may be placed at any desired location to erect a virtual boundary to limit or confine the movement of the robotic device.

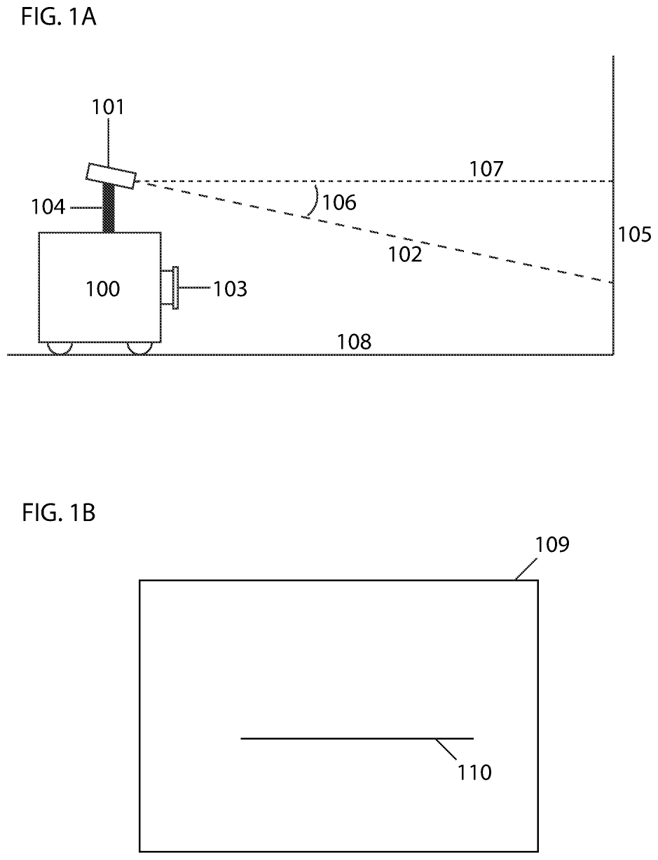

FIG. 1A illustrates a side view of a robotic device with an image sensor and line laser diode. The robotic device 100 includes image sensor 103 and line laser diode 101 which is mounted on the robotic device 100 by connecting member 104. Dashed line 102 represents the emissions from line laser diode 101. The line laser diode is positioned to emit the line laser at a slight downward angle 106 with respect to the work surface plane 108. Line 107 is shown for reference and is parallel to work surface 108. The line laser emissions emitted by line laser diode 101 are projected onto surfaces in front of the device, surface 105 in this particular case.

FIG. 1B illustrates a front view of the corresponding image captured by image sensor 103 of the line laser projected onto surface 105. The frame 109 represents the field of view of the image sensor 103. Line 110 represents the line laser projected by line laser diode 101 in FIG. 1A onto surface 105. Since surface 105 is flat, the projected line in the captured image is not skewed in any direction. A line laser projected onto uneven surfaces or surfaces with indentations will produce skewed or disjointed projections. Projected lines will appear larger as the distance to the surface on which the line laser is projected increases and will appear smaller as this distance decreases. Additionally, projected lines will appear lower as distance to the surface on which the line laser is projected increases as the line laser diode is angled downward with respect to the work surface plane. It should be noted that the line laser diode may alternatively be angled upward relative to the plane of the work surface, and projected lines in such cases will appear higher as distance to the surface increases.

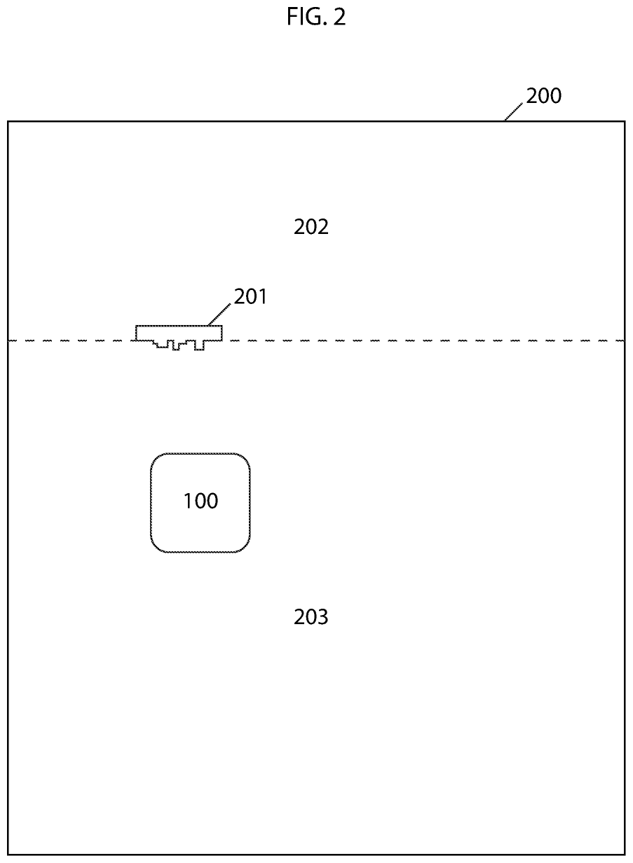

FIG. 2 illustrates a top view of the operation of the confinement system. A boundary component 201 and robotic device 100 are co-located within work area 200. The surface of boundary component 201 has a specific indentation pattern. The indentation pattern in the boundary component shown is an example. The indentation pattern can be in various configurations. The particular image produced by a line laser projected onto the surface of boundary component 201 shall be pre-programmed in a memory unit of the robotic device. The image processor iteratively compares received images against the pre-programmed surface indentation pattern of the boundary component. A margin of error may be defined to allow for a small amount of miscalculation or distortion.

In some embodiments, once the predetermined indentation pattern is detected the robotic device is configured to mark the location within the working map of the environment and draw a virtual boundary along the plane of the indentation pattern. As shown in FIG. 2, this would have the effect of dividing work area 200 into two zones: workspace 203 and off-limit zone 202 established by boundary component 201. It should be noted that the robotic device may be configured to take any variety of actions as a result of identifying the indentation pattern without limitation. For example, a robotic device may be configured to execute a first set of operations on a first side of a boundary component and a second set of operations on a second side of the boundary component. Or a robotic device may be configured to confine itself to one side of the boundary component for a predetermined amount of time. Or a robotic device may be configured to avoid crossing the virtual boundary. Or a robotic device may be configured to stay on a first and/or a second side of the virtual boundary. Or a robotic device may be configured to perform a deep cleaning of the area inside the virtual boundary.

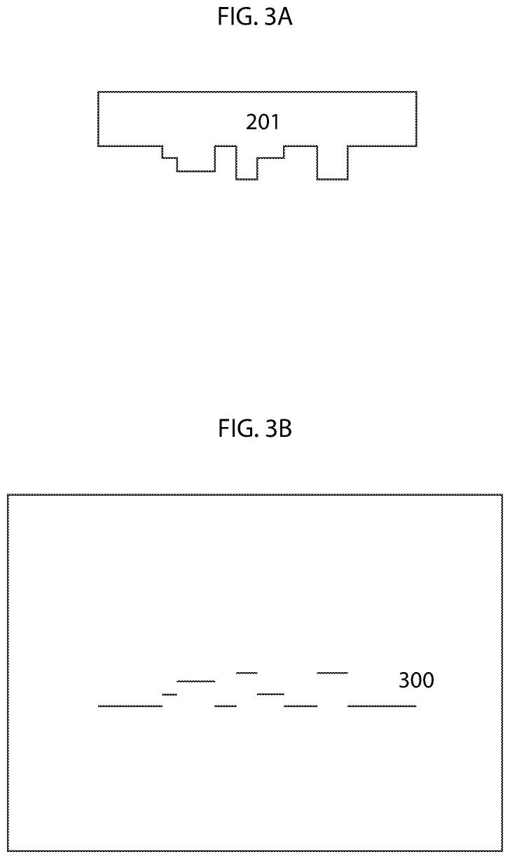

FIG. 3A illustrates a top view of boundary component 201. FIG. 3B illustrates a front view of the image captured of the line laser projected onto the surface of boundary component 201. The resulting indentation pattern produced is disjointed line 300 wherein different portions of the line appear staggered. Lines positioned lower correspond with areas of the indentation pattern which are further in distance from the image sensor while lines positioned higher correspond with areas of the indentation pattern which are closer in distance. The indentation pattern and thus corresponding disjointed lines are an example and are not limited to what is shown.

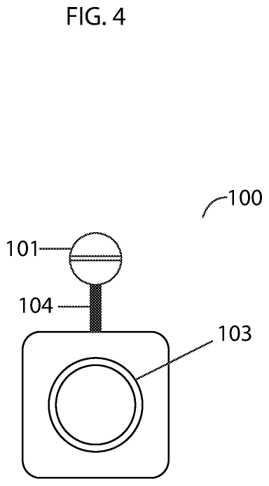

FIG. 4 illustrates a front view of robotic device 100. Robotic device 100 includes image sensor 103 and line laser diode 101 attached by connecting member 104.

The foregoing descriptions of specific embodiments of the invention have been presented for purposes of illustration and description. They are not intended to be exhaustive or to limit the invention to the precise forms disclosed.

1. A method for operating a robot, comprising:
capturing, with a sensor disposed on the robot, sensor data of objects within an environment of the robot as the robot moves within the environment;
identifying, with a processor, at least a first object among a plurality of objects within the environment based on the sensor data;
generating, with the processor, a virtual boundary adjacent to a location of the at least the first object; and
actuating the robot to avoid crossing locations within the environment corresponding with the virtual boundary.

2. The method of claim 1, further comprising:
marking, with the processor, a location of the at least the first object in a map of the environment.

3. The method of claim 1, wherein the processor generates a virtual boundary adjacent to a location of an object based on identifying the object as the at least the first object.

4. The method of claim 1, wherein identifying the at least the first object further comprises:
comparing, with the processor, the sensor data with at least one sensor data saved in a memory; and
identifying, with the processor, a match between the sensor data and the at least one sensor data saved in the memory.

5. The method of claim 4, wherein:
the sensor comprises an image sensor;
the sensor data of the objects within the environment comprises images of the objects within the environment; and
the at least one sensor data saved in the memory comprises at least one image saved in the memory.

6. The method of claim 1, further comprising:
identifying, with the processor, at least a second object among the plurality of objects within the environment based on the sensor data; and
actuating the robot to modify a movement path of the robot based on identifying an object as the at least the second object.

7. The method of claim 1, further comprising:
identifying, with the processor, at least a second object among the plurality of objects within the environment based on the sensor data; and
actuating the robot to execute a particular cleaning task based on identifying an object as the at least the second object.

8. The method of claim 1, further comprising:
identifying, with the processor, at least a second object among the plurality of objects within the environment based on the sensor data; and
actuating the robot to execute a first task in a first area of the environment and then a second task in a second area of the environment based on identifying an object as the at least the second object.

9. The method of claim 1, further comprising:
dividing, with the processor, the environment into two or more zones.

10. The method of claim 1, further comprising:
emitting, with a light emitter disposed on the robot, a light on surfaces of the objects within the environment, wherein a projection of the light on the surfaces of the objects falls within a field of view of the sensor.

11. The method of claim 10, wherein:
the sensor comprises an image sensor;
the sensor data of objects within the environment comprises images of the objects within the environment;
the images of the objects comprise the projection of the light on the surfaces of the objects; and
the method further comprises:
determining, with the processor, a distance of the surfaces of the objects relative to the robot based on a position or size of the projected light on the surfaces of the objects in the images of the objects.

12. A robot, comprising:
a chassis;
a set of wheels coupled to the chassis; and
a plurality of sensors;
wherein:
the sensor is configured to capture sensor data of objects within an environment of the robot as the robot moves within the environment;
a processor is configured to identify at least a first object based on the sensor data;
the processor is further configured to generate a virtual boundary adjacent to a location of the at least the first object based on identifying the at least the first object among a plurality of objects within the environment; and
the robot is configured to avoid crossing locations within the environment corresponding with the virtual boundary.

13. The robot of claim 12, wherein:
the processor is further configured to mark a location of the at least the first object in a map of the environment.

14. The robot of claim 12, wherein the processor is configured to generate a virtual boundary adjacent to a location of an object based on identifying the object as the at least the first object.

15. The robot of claim 12, wherein identifying the at least the first object further comprises:
comparing the sensor data with at least one sensor data saved in a memory; and
identifying a match between the sensor data and the at least one sensor data saved in the memory.

16. The robot of claim 15, wherein:
the sensor comprises an image sensor;
the sensor data of the objects within the environment comprises images of the objects within the environment; and
the at least one sensor data saved in the memory comprises at least one image saved in the memory.

17. The robot of claim 12, wherein:
the processor is further configured to identify at least a second object among the plurality of objects within the environment based on the sensor data; and
the robot is further configured to modify a movement path of the robot based on identifying an object as the at least the second object.

18. The robot of claim 12, wherein:
the processor is further configured to identify at least a second object among the plurality of objects within the environment based on the sensor data; and
the robot is further configured to execute a particular cleaning task based on identifying an object as the at least the second object.

19. The robot of claim 12, wherein:
the processor is further configured to at least a second object among the plurality of objects within the environment based on the sensor data; and
the robot is further configured to execute a first task in a first area of the environment and then a second task in a second area of the environment based on identifying an object as the at least the second object.

20. The robot of claim 12, wherein:
the processor is further configured to divide the environment into two or more zones; and
a light emitter disposed on the robot is configured to emit a light on surfaces of the objects within the environment, wherein a projection of the light on the surfaces of the objects falls within a field of view of the sensor.
